(19) United States
(12) Patent Application Publication
(10) Pub. No.: US 2026/0022654 A1
(43) Pub. Date: Jan. 22, 2026

(54) METHOD AND DEVICE FOR PREDICTING TEMPERATURE OF ENGINE COOLING SYSTEM, AND MEDIUM

(71) Applicant: BEIJING CO WHEELS TECHNOLOGY CO., LTD., Beijing (CN)

(72) Inventors: Hongyang ZHANG, Beijing (CN); Ying MENG, Beijing (CN); Chunshan MA, Beijing (CN); Jian XUE, Beijing (CN); Kaifeng LIU, Beijing (CN); Yue MENG, Beijing (CN); Yunpeng NING, Beijing (CN)

(21) Appl. No.: 18/875,799

(22) PCT Filed: Jun. 16, 2023
(86) PCT No.: PCT/CN2023/100621

§ 371 Date: Dec. 17, 2024

(30) Foreign Application Priority Data
Jun. 17, 2022 (CN) 202210684827.3

(51) Int. Cl. F01P 11/16; F01P 3/02

(52) U.S. Cl. CPC F01P 11/16; F01P 3/02; F01P 2003/021; F01P 2023/08; F01P 2025/30; F01P 2025/31

(57) ABSTRACT

A method for predicting a temperature of for an engine cooling system, includes: obtaining a first temperature of the engine cooling system at an initial moment, operating parameters of an engine, and a target moment, in which the engine cooling system comprises at least cooling water, an inner cylinder wall, and an outer cylinder wall; determining a number of unit time steps required from the initial moment to the target moment according to a preset unit time step; and obtaining a target temperature of the engine cooling system at the target moment by performing a set number of iterative calculations according to the first temperature and the operating parameters of the engine.

### CROSS-REFERENCE TO RELATED APPLICATIONS

This application is a national phase entry under 35 U.S.C. § 371 of International Application No. PCT/CN2023/100621, filed on Jun. 16, 2023, which claims priority to Chinese Patent Application No. 202210684827.3, filed on Jun. 17, 2022, the entire disclosures of which are hereby incorporated herein by reference.

### TECHNICAL FIELD

The disclosure relates to the technical field of vehicle thermal management, in particular to a method and an apparatus for predicting a temperature of an engine cooling system, a device, a medium, and a vehicle.

### BACKGROUND

An automotive thermal management system needs to automatically adjust a cooling intensity according to driving conditions and environmental conditions, to ensure the corresponding components work within an optimal temperature range, specifically to ensure the engine works within a corresponding optimal temperature range.

At present, in order to ensure the engine works within the optimal temperature range, a temperature prediction model may be constructed to calculate a temperature of an engine at different moments, but the existing model has a slow calculation speed and a low accuracy.

### SUMMARY

In a first aspect, a computer implemented method for predicting a temperature of an engine cooling system is provided. The method includes: obtaining a first temperature of the engine cooling system at an initial moment, operating parameters of an engine and a target moment, in which the engine cooling system includes at least cooling water, an inner cylinder wall and an outer cylinder wall; determining a number of unit time steps required from the initial moment to the target moment according to a preset unit time step; and obtaining a target temperature of the engine cooling system at the target moment by performing a set number of iterative calculations according to the first temperature and the operating parameters of the engine, in which the set number is equal to the number of unit time steps.

In a second aspect, an embodiment of the present disclosure provides a device for predicting a temperature of an engine cooling system. The device includes a processor, a memory, and programs or instructions stored in the memory and executable on the processor. The processor is configured to: obtain a first temperature of the engine cooling system at an initial moment, operating parameters of an engine and a target moment, wherein the engine cooling system comprises at least cooling water, an inner cylinder wall and an outer cylinder wall; determine a number of unit time steps required from the initial moment to the target moment according to a preset unit time step; and obtain a target temperature of the engine cooling system at the target moment by performing a set number of iterative calculations according to the first temperature and the operating parameters of the engine, wherein the set number is equal to the number of unit time steps.

In a third aspect, an embodiment of the present disclosure provides a computer-readable storage medium, on which programs or instructions is stored. When the programs or instructions are executed by a processor, the steps of the method for predicting a temperature of an engine cooling system are implemented as described in the first aspect of the present disclosure.

It should be understood that the foregoing general description and the following detailed description are exemplary and explanatory only, which are not limited in the present disclosure.

### BRIEF DESCRIPTION OF THE DRAWINGS

The drawings herein are incorporated into the specification and constitute a part of the specification, illustrate embodiments consistent with the present disclosure, and together with the specification are used to explain the principles of the present disclosure, and do not constitute improper limitations on the present disclosure.

FIG. 1 is a flowchart of a method for predicting a temperature of an engine cooling system according to an embodiment of the present disclosure.

FIG. 2 is a process diagram of each iterative calculation involved in an embodiment of the present disclosure.

FIG. 3 is a diagram of a double-layer flat plate model for an engine involved in an embodiment of the present disclosure.

FIG. 4 is a structure diagram of an apparatus for predicting a temperature of an engine cooling system according to an embodiment of the present disclosure.

FIG. 5 is a structure diagram of an electronic device according to an embodiment of the present disclosure.

### DETAILED DESCRIPTION

In order to more clearly understand the above-mentioned objects, features and advantages of the present disclosure, solutions of the present disclosure may be further described below. It should be noted that, in the absence of conflicts, the embodiments of the present disclosure and the features therein may be combined with each other.

In the following description, many specific details are set forth to facilitate a full understanding of the present disclosure, but the present disclosure may also be implemented in other ways different from those described herein. It is obvious that the embodiments in the specification are only a part of the embodiments of the present disclosure, rather than all of the embodiments.

Before introducing the implementations of the present disclosure, the background art of the present disclosure is first introduced.

At present, in order to ensure that an engine works within an optimal temperature range, a temperature prediction model may be constructed. Specifically, there may be two types of models: a physical model and a fitting model, for calculating a temperature of the engine at different moments. However, the existing physical model and fitting model have the following defects.

For the physical model, the existing physical model is calculated based on a time step and a space step. For example, an inner cylinder wall of an engine to be calculated may be divided into several sections from an inner side of the inner cylinder wall to an outer side of the inner cylinder wall, and a temperature of each section from the inner side of the inner cylinder wall to the outer side of the inner cylinder wall is calculated in order, until a temperature of the outer side of the inner cylinder wall is calculated. However, in actual application, a user only wants to know the temperature of the outer side of the inner cylinder wall, but does not need to know a temperature of a middle part from the inner side to the outer side of the inner cylinder wall. Therefore, the above physical model needs to calculate temperatures of many middle sections, resulting in a slow calculation speed. Moreover, when the above physical model predicts the temperature, the physical model requires many characteristic parameters of the engine cooling system, such as a roughness and a diameter of the cylinder wall. However, in the actual usage of the engine, factors such as water stains may cause the cylinder wall roughness to change. The cylinder wall roughness of a different engine may be different. Therefore, in the calculation process, it is necessary to obtain cylinder wall roughness values of engines to be predicted one by one, which affects the calculation efficiency, also causes the physical model to reflect only common characteristics of the engines and cannot simulate personality of an engine. In actual application, the calculation is generally based on a cylinder wall roughness in an engine manual. However, after the engine is used, its actual cylinder wall roughness may be inconsistent with the cylinder wall roughness in the manual, which may cause the calculated temperature to be inaccurate.

For the fitting model, a large amount of experimental data is required for training and simulation, which is time-consuming and labor-intensive. In addition, the engine system has a high degree of nonlinearity, and it is difficult to achieve a high level of model accuracy. The fitting model may only simulate operating conditions within a boundary of the training data, with a poor prediction ability and a poor model robustness, and cannot reflect the physical process. Therefore, it is difficult to correct errors in certain operating conditions. In addition, the fitting model is suitable for steady-state or static models, and has a poor dynamic performance.

In order to solve the above problems, an embodiment of the present disclosure provides an method for predicting a temperature of an engine cooling system. In this method, the number of unit time steps required from the initial moment to the target moment is obtained, and the set number of iterative calculations are performed according to the first temperature of the engine cooling system at the initial moment and the operating parameters of the engine to obtain the target temperature of the engine cooling system at the target moment. In this way, when calculating the target temperature of the engine cooling system at the target moment, there is no need to refer to immeasurable parameters caused during the use of the engine, such as a cylinder wall roughness of the engine. The target temperature of the engine cooling system at the target moment calculated in this method is more accurate. When calculating the target temperature of the engine cooling system at the target moment, the calculation only needs to rely on the first temperature of the engine cooling system at the initial moment and the operating parameters of the engine, without relying on too many other parameters, thereby saving a calculation time and improving a calculation efficiency of the target temperature of the engine cooling system at the target moment.

The method for predicting a temperature of an engine cooling system according to embodiments of the present disclosure is described in detail below with reference to the accompanying drawings via specific embodiments and their application scenarios.

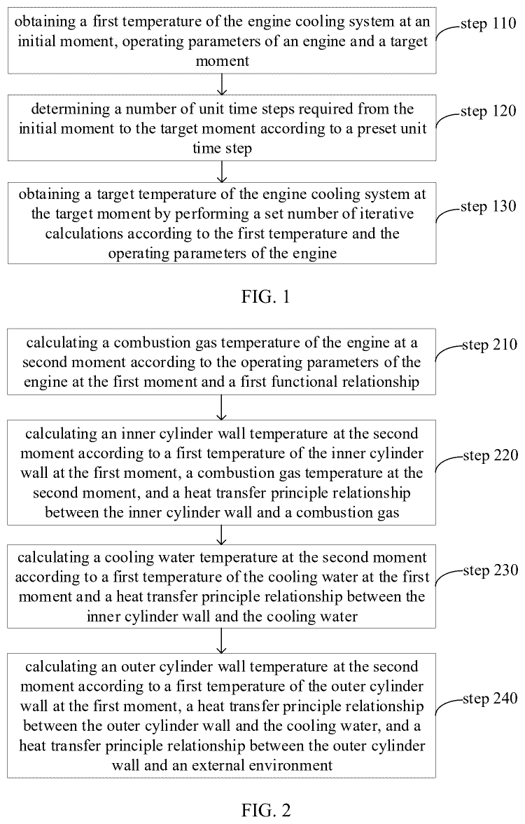

FIG. 1 is a flowchart of a method for predicting a temperature of an engine cooling system according to an embodiment of the present disclosure. The execution subject of the method for predicting a temperature of an engine cooling system may be a server. It should be noted that the above-mentioned execution subject does not constitute a limitation on the present disclosure.

As shown in FIG. 1, the method for predicting a temperature of an engine cooling system according to the embodiment of the present disclosure may include the following steps 110 to 130.

At 110, a first temperature of the engine cooling system at an initial moment, operating parameters of an engine, and a target moment are obtained.

The cooling system may at least include cooling water, an inner cylinder wall and an outer cylinder wall.

At 120, a number of unit time steps required from the initial moment to the target moment is determined according to a preset unit time step.

At 130, a set number of iterative calculations are performed according to the first temperature and the operating parameters of the engine to obtain a target temperature of the engine cooling system at the target moment.

The set number may be equal to the number of unit time steps.

A first functional relationship may be obtained by fitting a double-layer flat plate model corresponding to the engine. Specifically, the first functional relationship may be a functional relationship between a combustion gas temperature and the operating parameters of the engine.

In an embodiment of the present disclosure, by obtaining the number of unit time steps required from the initial moment to the target moment, a set number of iterative calculations are performed according to the first temperature of the engine cooling system at the initial moment and the operating parameters of the engine, to obtain the target temperature of the engine cooling system at the target moment. In this way, when calculating the target temperature of the engine cooling system at the target moment, there is no need to refer to immeasurable parameters caused during the use of the engine such as the cylinder wall roughness of the engine. The target temperature of the engine cooling system at the target moment calculated in this method is more accurate. When calculating the target temperature of the engine cooling system at the target moment, the calculation only needs to rely on the first temperature of the engine cooling system at the initial moment and the operating parameters of the engine, without relying on too many other parameters, thereby saving the calculation time and improving the calculation efficiency of the target temperature of the engine cooling system at the target moment.

The method for predicting a temperature of an engine cooling system according to an embodiment of the present disclosure is described in detail below.

First, the step 110 is introduced to obtain a first temperature of the engine cooling system at the initial moment, operating parameters of the engine and a target moment.

The cooling system may at least include cooling water, an inner cylinder wall and an outer cylinder wall.

The initial moment may be a moment at which a temperature of the engine cooling system starts to be predicted.

The first temperature may be a temperature of the engine cooling system at the initial moment.

The operating parameters may be operating state parameters of the engine, specifically a speed and a torque of the engine.

The target moment may be a moment at which the temperature of the engine cooling system is to be predicted.

In an example, if temperatures of the engine cooling system within 1 hour in future will be predicated starting from 8:00 a.m. on Apr. 18, 2022, 8:00 a.m. on Apr. 18, 2022 is the initial moment, and 1 hour later (i.e. 9:00 a.m. on Apr. 18, 2022) is the target moment.

In some embodiments of the present disclosure, the first temperature of the engine cooling system at the initial moment and the operating parameters of the engine may be obtained by sensors on the engine or may be obtained through real-time testing, and the specific obtaining way is not limited herein.

At step 120, a number of unit time steps required from the initial moment to the target moment is determined according to a preset unit time step.

The preset unit time step may be a pre-set unit time step. For example, the unit time step can be 5 minutes or 10 minutes. The specific setting can be based on user needs and is not limited here.

Continuing to the above example, the initial moment is 8:00 am on Apr. 18, 2022, and the target moment is 9:00 am on Apr. 18, 2022, that is, a total of 60 minutes from the initial moment to the target moment. If the preset unit time step is 5 minutes, the number i of unit time steps required from the initial moment to the target moment is that, i=60/5=12.

At step 130, a set number of iterative calculations are performed according to the first temperature and the operating parameters of the engine to obtain a target temperature of the engine cooling system at the target moment.

The set number of iterations may be a preset number of iterations. Specifically, the set number may be equal to the number of unit time steps required from the initial moment to the target moment determined in the above step 120.

The target temperature may be a temperature of the engine cooling system at the target moment obtained by performing iterative calculations for a set number of times according to the first temperature and the operating parameters of the engine.

As shown in FIG. 2, in some embodiments of the present disclosure, in order to further improve the calculation efficiency of the target temperature of the engine cooling system at the target moment, each iterative calculation step may include the steps 210 to 240.

At step 210, a combustion gas temperature of the engine at a second moment is calculated according to the operating parameters of the engine at the first moment and a first functional relationship.

The first functional relationship may be obtained by fitting a double-layer flat plate model corresponding to the engine. Specifically, the first functional relationship may be a functional relationship between a combustion gas temperature and the operating parameters of the engine.

In some embodiments of the present disclosure, the first moment may be an initial moment, or a moment between the initial moment and the target moment. An initial value of the first moment may be the initial moment.

The second moment may be a moment corresponding to a next unit time step of the first moment. The first moment and the second moment may be separated by a unit time step.

Continuing to the above example, the initial moment is 8:00 am on Apr. 18, 2022, and the target moment is 9:00 am on Apr. 18, 2022. If the preset unit time step is 5 minutes and the first moment is 8:30 am on Apr. 18, 2022, the second moment can be 8:35 am on Apr. 18, 2022.

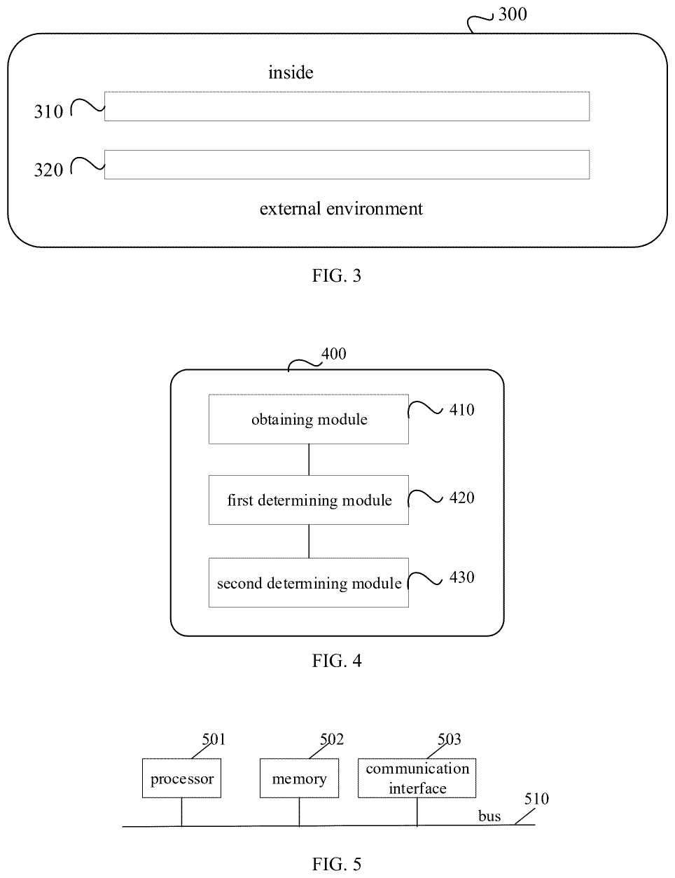

In some embodiments of the present disclosure, a heat transfer model of the engine may be simplified. Specifically, the heat transfer model of the engine may be simplified to a heat transfer model with double-layer plates (as shown in FIG. 3). In FIG. 3, combustion gas (not shown) is inside the engine 300, and cooling water (not shown) is between the inner cylinder wall 310 and the outer cylinder wall 320. After the combustion gas is burned, heat flows into the inner cylinder wall 310 through convection heat transfer. At this time, the inner cylinder wall is heated, and the inner cylinder wall heats the cooling water. The cooling water gains the energy and its temperature rises, causing that the outer cylinder wall 320 is heated. At the same time, spontaneous heat transfer occurs between the outer cylinder wall and the external environment.

In subsequent embodiments of the present disclosure, it may be assumed that a cylinder head is integrated with the inner cylinder wall, there is no heat conduction between the cylinder head and the outer cylinder wall, and the cylinder wall may be heated uniformly without considering an internal temperature difference.

In some embodiments of the present disclosure, the functional relationship between the combustion gas temperature and the operating parameters of the engine may be shown in formula (1).

$${T}_{gas} = a * {n}^{2} - b * {T}^{2} - c * n * T + d * n + f * T + h \qquad ( 1 )$$

In formula (1), T_{gas} is a virtual combustion temperature; n is an engine speed, T is an engine torque; a, b, c, d, f and h are all constants, which are determined according to a model of the engine.

In some embodiments of the present disclosure, the constants in the above formula (1) can be: a=−9.04e-08, b=0.000844, c=7.737e-0.5, d=0.0178, f=0.552, h=91.043.

In some embodiments of the present disclosure, the engine has reached a stable high temperature in steady-state conditions, so an intake temperature at the beginning of combustion is higher than an intake temperature of the cold start. In order to better fit the intake temperature of the cold start, a inlet water temperature is used to represent different cold start stages to correct this phenomenon. After correcting the above formula (1), formula (2) is obtained.

$${T}_{gas} = {( a * {n}^{2} - b * {T}^{2} - c * n * T + d * n + f * T + h )}^{\frac{{T}_{w , in}}{{T}_{w , in , measuτe}}} \qquad ( 2 )$$

In formula (2), T_{w,in} is an intake temperature at a cold start; T_{w,in,measure} is an intake temperature at the beginning of combustion.

It should be noted that the temperatures in the correction formula (i.e., formula (2)) are all Kelvin temperatures.

In some embodiments of the present disclosure, in order to further improve the accuracy and efficiency of predicting the temperature of the engine cooling system, before step 110, the above mentioned method for predicting a temperature of an engine cooling system may further include:
obtaining a first corresponding relationship for a heat transfer coefficient between the operating parameters of the engine and the combustion gas, by fitting historical operating parameters of the engine, the heat transfer coefficient between the historical operating parameters and the combustion gas;
obtaining a second corresponding relationship for a heat transfer coefficient between a mass flow rate of cooling water and the cylinder wall of the engine, by fitting the mass flow rate of cooling water, the heat transfer coefficient between the mass flow rate of cooling water and the cylinder wall of the engine; and
obtaining the functional relationship between the combustion gas temperature and the operating parameters of the engine, by fitting the first corresponding relationship and the second corresponding relationship according to a double-layer flat plate model corresponding to the engine and an energy conservation formula for steady-state heat transfer between the cooling water and the combustion gas within the engine.

The historical operating parameters may be operating parameters of the engine before the temperature of the engine cooling system is predicted at the current moment.

The first corresponding relationship may be a relationship for the heat transfer coefficient between the operating parameters of the engine and the combustion gas.

The second corresponding relationship may be a relationship for the heat transfer coefficient between the mass flow rate of cooling water and the cylinder wall of the engine.

In some embodiments of the present disclosure, the historical operating parameters of the engine, and the heat transfer coefficient between the historical operating parameters and the combustion gas may be fitted to obtain the first corresponding relationship for the heat transfer coefficient between the operating parameters of the engine and the combustion gas as shown in formula (3).

$$α 1 = ( a 1 * {n}^{2} - b 1 * {T}^{2} - c 1 * n * T + d 1 * n + f 1 * T + h 1 ) \qquad ( 3 )$$

In formula (3), α1 is a heat transfer coefficient between the operating parameters of the engine and the combustion gas; n is an engine speed, T is an engine torque; a1, b1, c1, d1, f1 and h1 are all constants, which are determined according to a model of the engine.

In some embodiments of the present disclosure, the constants in the above formula (3) may be: a1=−6.048e-07, b1=0.00028, c1=0.000143, d1=0.0497, f1=0.00868, h1=35.6212.

In some embodiments of the present disclosure, the mass flow rate of cooling water, and the heat transfer coefficient between the mass flow rate of cooling water and the cylinder wall of the engine may be fitted to obtain the second corresponding relationship for the heat transfer coefficient between the mass flow rate of cooling water and the cylinder wall of the engine as shown in formula (4).

$$α 2 = ( a 2 * {\dot{m}}^{2} + b 2 * \dot{m} + c 2 ) \qquad ( 4 )$$

In formula (4), α2 is a heat transfer coefficient between the mass flow rate of cooling water and the cylinder wall of the engine; n is a mass flow rate of engine cooling water, and a2, b2 and c2 are all constants, which are determined according to a model of the engine.

In some embodiments of the present disclosure, the constants in the above formula (4) may be: a2=−2561.3, b2=186.6, c2=971.9.

In some embodiments of the present disclosure, after obtaining the first corresponding relationship and the second corresponding relationship, the first corresponding relationship and the second corresponding relationship may be fitted according to the double-layer flat plate model corresponding to the engine and the energy conservation formula for steady-state heat transfer between the cooling water and the combustion gas in the engine, to obtain the functional relationship between the combustion gas temperature and the operating parameters of the engine.

In an embodiment of the present disclosure, the heat transfer coefficient for the engine cooling system is calculated, the functional relationship between the combustion gas temperature and the operating parameters of the engine may be calculated based on the heat transfer coefficient without the need for other redundant calculations, thereby improving the calculation efficiency of the functional relationship between the combustion gas temperature and the operating parameters of the engine, and thus improving the efficiency of predicting the temperature of the engine cooling system. Moreover, when calculating the heat transfer coefficient between the engine cooling system, only the operating parameters of the engine and the mass flow rate of the cooling water are used, without the need for other less accurate parameters such as the cylinder wall roughness, thereby improving the accuracy of predicting the temperature of the engine cooling system.

In some embodiments of the present disclosure, in order to further improve the accuracy and efficiency of predicting the temperature of the engine cooling system, obtaining the functional relationship between the combustion gas temperature and the operating parameters of the engine, by fitting the first corresponding relationship and the second corresponding relationship according to the double-layer flat plate model corresponding to the engine and the energy conservation formula for steady-state heat transfer between the cooling water and the combustion gas in the engine may specifically include:
obtaining a heat conduction thermal resistance relationship within the engine, by fitting the first corresponding relationship and the second corresponding relationship according to a first heat transfer area between the inner cylinder wall and the combustion gas, a second heat transfer area between the inner cylinder wall and the cooling water, and a heat conduction area of the inner cylinder wall;
obtaining a third relationship by performing integration on a length from an inlet to an outlet of the inner cylinder wall within the engine according to the heat conduction thermal resistance relationship and the double-layer plate model corresponding to the engine, as well as an energy conservation formula for steady-state heat transfer between the cooling water and the combustion gas within the engine; and
obtaining a functional relationship between the combustion gas temperature and the operating parameters of the engine by performing a quadratic function fitting for the third relationship and the operating parameters of the engine.

The third relationship may be a corresponding relationship between the combustion gas, an inlet temperature of the cooling water and an outlet temperature of the cooling water.

In some embodiments of the present disclosure, during the steady-state process, the temperature of the outer cylinder wall of the engine and the cooling water temperature are very close, so it may be determined/deemed that a heat transfer between the cooling water and the outer cylinder wall is small and has little effect on the temperature change of the cooling water. When the change of cooling water temperature is considered, a heat transfer between cooling water and inner cylinder wall is mainly considered. The first corresponding relationship and the second corresponding relationship are fitted in a steady-state heat transfer formula with heat transfer in series, according to the heat transfer area between the inner cylinder wall and the combustion gas, the heat transfer area between the inner cylinder wall and cooling water, and the heat conduction area of inner cylinder wall, and the heat conduction thermal resistance relationship within the engine may be obtained as shown in the following formula (5).

$$Q = ( {T}_{gas} - {T}_{w} ) / ( \frac{1}{\frac{1}{α 1 * A 1} + \frac{1}{λ 1 * A 2} + \frac{1}{α 2 * A 3}} ) \qquad ( 5 )$$

In formula (5), T_{gas} is a combustion gas temperature; T_{w} is a cooling water temperature, A1 is a heat transfer area between the combustion gas and the inner cylinder wall; A2 is a heat conduction area of the inner cylinder wall; A3 is a heat transfer area between the inner cylinder wall and the cooling water; λ1 is a thermal conductivity of the inner cylinder wall (which is a constant value and related to the material of the inner cylinder wall); α1 is a heat transfer coefficient between the operating parameters of the engine and the combustion gas; α2 is a heat transfer coefficient between the mass flow rate of cooling water and the cylinder wall of the engine.

In some embodiments of the present disclosure, for the sake of convenience of calculation, A1=A2=A3 and

$$α = 1 / ( \frac{1}{α 1} + \frac{1}{λ 1} + \frac{1}{α 2}$$

can be used, and then formula (6) can be obtained.

$$Q = α * A * ( {T}_{gas} - {T}_{w} ) \qquad ( 6 )$$

In formula (6)

$$α = 1 / ( \frac{1}{α 1} + \frac{1}{λ 1} + \frac{1}{α 2} ;$$

A1=A2=A3=A; T_{gas} is a combustion gas temperature; T_{w} is a cooling water temperature.

Then, according to energy conservation formulas (7) and (8) for steady-state heat transfer, formula (7) and (8) are combined, and integration is performed on the length from the inlet to the outlet of the inner cylinder wall in the engine to obtain the third relationship between the inlet temperature of the combustion gas, the cooling water and the outlet temperature of the cooling water (i.e., formula (9)).

$$Q = \dot{m} * {C}_{p} * {dT}_{w} \qquad ( 7 )$$

In formula (9), Cₚ is a constant-pressure specific heat capacity of the cooling water; m is a mass flow rate of the engine cooling water; dT_{w} is a difference between the inlet temperature and the outlet temperature of the cooling water.

$$Q = α * dA * ( {T}_{gas} - {T}_{w} ) = α * {L}_{c} * dx * ( {T}_{gas} - {T}_{w} ) \qquad ( 8 )$$

where L_{c} is a characteristic length of a heat transfer component (inner cylinder wall, cooling water, combustion gas and outer cylinder wall), indicating a heat transfer area per unit length, x is a length of the heat transfer component;

$$α = 1 / ( \frac{1}{α 1} + \frac{1}{λ 1} + \frac{1}{α 2} ) ;$$

T_{gas} is the combustion gas temperature; T_{w} is a cooling water temperature.

$$\frac{{T}_{gas} - {T}_{w , out}}{{T}_{gas} - {T}_{w , in}} = {e}^{- \frac{α * A}{m * {C}_{p}}} \qquad ( 9 )$$

where T_{gas} is a combustion gas temperature; T_{w,out} is a cooling water outlet temperature, T_{w,in} is a cooling water inlet temperature; m is the mass of water; A1=A2=A3=A;

$$\begin{matrix}α = 1 / ( \frac{1}{α 1} + \\ \frac{1}{λ 1} + \frac{1}{α 2} ;\end{matrix}$$

Cₚ is a constant-pressure specific heat capacity of the cooling water.

For the sake of simplicity of calculation, let

$$N = {e}^{- \frac{α * A}{m * {C}_{p}}}$$

and formula (9) may thus be transformed to obtain formula (10):

$${T}_{gas} = ( {T}_{w , o u t} - N * {T}_{w , i n} ) / ( 1 - N ) \qquad ( 10 )$$

In formula (10), T_{gas} is a combustion gas temperature; T_{w,out} is a cooling water outlet temperature; T_{w,in} is a cooling water inlet temperature.

In this way, the steady-state experimental data may be obtained to calculate T_{gas} corresponding to each operating condition, so that the corresponding relationship between the engine speed, the engine torque and the combustion gas temperature is obtained.

It should be noted that the combustion temperature of the gas in the engine changes with the stroke, but due to the thermal inertia of the cylinder, the temperature of the inner cylinder wall does not change much. Therefore, it may be assumed that the combustion acts on the inner cylinder wall of the engine with an average temperature within four strokes. After formula (10) is obtained, a quadratic function fitting may be performed on formula (10) and the operating parameters of the engine, to obtain the functional relationship between the combustion gas temperature and the operating parameters of the engine shown in the above formula (1).

In an embodiment of the present disclosure, the first and second corresponding relationships are fitted according to the first heat transfer area between the inner cylinder wall and the combustion gas, the second heat transfer area between the inner cylinder wall and the cooling water, and the heat conduction area of the inner cylinder wall, to obtain the heat conduction thermal resistance relationship within the engine; the third relationship for the combustion gas is then obtained according to the heat conduction thermal resistance relationship, and the energy conservation formula for steady-state heat transfer between the cooling water and the combustion gas within the engine, a quadratic function fitting is performed on the third relationship and the operating parameters of the engine, so that the functional relationship between the combustion gas temperature and the operating parameters of the engine can be obtained. In the process of calculating the functional relationship between the combustion gas temperature and the operating parameters of the engine, only the heat transfer area between the inner cylinder wall and the combustion gas, the heat transfer area between the inner cylinder wall and the cooling water, and the heat conduction area of the inner cylinder wall are used, without referring to other inaccurate parameters, so as to obtain the accurate functional relationship between the combustion gas temperature and the operating parameters of the engine, thereby improving the accuracy of predicting the temperature of the engine cooling system. In addition, in the calculation process, there is no need to calculate the temperature in the middle of the heat transfer component, there is only a need to calculate the inlet temperature and the outlet temperature of the heat transfer component, thereby improving the calculation efficiency of the functional relationship between the combustion gas temperature and the operating parameters of the engine, and improving the efficiency of predicting the temperature of the engine cooling system.

At step 220, an inner cylinder wall temperature at the second moment is calculated according to a first temperature of the inner cylinder wall at the first moment, a combustion gas temperature at the second moment, and a heat transfer principle relationship between the inner cylinder wall and the combustion gas.

In some embodiments of the present disclosure, after calculating the combustion gas temperature at the second moment, the inner cylinder wall temperature at the second moment can be obtained according to the first temperature of the inner cylinder wall at the first moment and the combustion gas temperature at the second moment, and the heat transfer principle relationship between the inner cylinder wall and the combustion gas.

In some embodiments of the present disclosure, the heat transfer principle relationship between the inner cylinder wall and the combustion gas is shown in the above formula (6), where T_{gas} can be the combustion gas temperature at the second moment, and T_{w} is the inner cylinder wall temperature obtained at the first moment, so that a heat transfer amount Q between the inner cylinder wall and the combustion gas may be calculated.

Then, based on a variation of the above formula (7), the inner cylinder wall temperature at the second moment can be calculated according to the heat transfer amount Q between the inner cylinder wall and the combustion gas, and the inner cylinder wall temperature at the first moment.

It should be noted that, since formula (7) is an energy conservation formula for steady-state heat transfer of the cooling water, which aims at solving the inner cylinder wall temperature. Therefore, the energy conservation formula for steady-state heat transfer of the cooling water in formula (7) may be changed to the energy conservation formula for steady-state heat transfer of the inner cylinder wall. Specifically, mf in formula (7) can be replaced by the mass of the inner cylinder wall, Cₚ can be replaced by a specific heat capacity of the inner cylinder wall, and dT_{w} can be replaced by dT_{B}. dT_{B} represents the difference between the first temperature of the inner cylinder wall at the first moment and the temperature of the inner cylinder wall at the second moment.

Thus, the inner cylinder wall temperature at the second moment can be obtained according to the variation of formula (7).

At step 230, a cooling water temperature at the second moment is calculated according to a first temperature of the cooling water at the first moment and a heat transfer principle relationship between the inner cylinder wall and the cooling water.

In some embodiments of the present disclosure, in order to accurately calculate the cooling water temperature at the second moment, the step 230 may specifically include:
calculating, based on a steady-state heat transfer formula, a first heat transfer amount between the cooling water and the inner cylinder wall according to the first temperature of the cooling water at the first moment and the inner cylinder wall temperature at the second moment;
obtaining a first relationship by performing integration on a length from an inlet to an outlet of the inner cylinder wall according to the first heat transfer amount;
calculating a first outlet water temperature of the cooling water after heat transfer through the inner cylinder wall according to the first relationship, the first temperature of the cooling water at the first moment and the inner cylinder wall temperature at the second moment;
calculating a second heat transfer amount between the cooling water and the outer cylinder wall according to the first outlet water temperature and the first temperature of the outer cylinder wall at the first moment;
obtaining a second relationship by performing integration on the length from the inlet to the outlet of the outer cylinder wall according to the second heat transfer amount; and
calculating the second outlet water temperature of the cooling water after heat transfer through the outer cylinder wall according to the second relationship, the first outlet water temperature and the first temperature of the outer cylinder wall at the first moment, in which the cooling water temperature at the second moment is the second outlet water temperature.

The first heat transfer amount may be a heat transfer amount between the cooling water and the inner cylinder wall.

The first outlet water temperature may be a temperature of the cooling water after heat transfer through the inner cylinder wall.

The first relationship may be a relationship between the first temperature of the cooling water, the first outlet water temperature of the cooling water after heat transfer through the inner cylinder wall, and the inner cylinder wall temperature.

The second heat transfer amount may be a heat transfer amount between the cooling water and the outer cylinder wall.

The second outlet water temperature may be a temperature of the cooling water after heat is transferred/exchanged to the outer cylinder wall.

The second relationship may be a relationship between the first outlet water temperature, the second outlet water temperature of the cooling water after heat transfer through the outer cylinder wall, and the first temperature of the outer cylinder wall at the first moment.

In some embodiments of the present disclosure, for heat transfer of a flat plate, the first heat transfer amount between the cooling water (having a small volume of cooling water flow) and the inner cylinder wall may be calculated according to the first temperature of the cooling water at the first moment and the temperature of the inner cylinder wall at the second moment, which is in formula (11):

$$Q = α * dA * ( {T}_{B} - {T}_{w} ) = α * {L}_{c} * dx * ( {T}_{B} - {T}_{w} ) \qquad ( 11 )$$

In formula (11), α is a heat transfer coefficient between the cooling water and the inner cylinder wall (i.e., α2 in formula (4)); L_{c} is a characteristic length of the inner cylinder wall, indicating a heat transfer area per unit length; x is a length of the inner cylinder wall; T_{B} is an inner cylinder wall temperature at the second moment; and T_{w} is a first temperature of the cooling water at the first moment.

After heat transfer between the inner cylinder wall and the cooling water, the internal energy of the cooling water changes to formula (12):

$$Q = \dot{m} * {C}_{p} * {dT}_{w} \qquad ( 12 )$$

The above formula (12) is consistent with formula (7) and will not be repeated here.

Formula (11) and formula (12) are combined, and integration is performed on the length from the inlet to the outlet of the inner cylinder wall to obtain the first relationship between the first temperature of the cooling water, the first outlet temperature of the cooling water after heat transfer through the inner cylinder wall, and the inner cylinder wall temperature as shown in formula (13):

$$\frac{{T}_{B} - {T}_{w , out}}{{T}_{B} - {T}_{w , in}} = {e}^{- \frac{α * A}{m * {C}_{p}}} \qquad ( 13 )$$

In formula (13), T_{B} is an inner cylinder wall temperature at the second moment; T_{w,in} is a first temperature of the cooling water at the first moment; T_{w,out} is a first outlet water temperature of the cooling water after heat transfer through the inner cylinder wall; α is a heat transfer coefficient between the cooling water and the inner cylinder wall (i.e., α2 in formula (4)); A is a heat conduction area of the inner cylinder wall; m is the mass of the cooling water; and Cₚ is a constant-pressure specific heat capacity of the cooling water.

Thus, the first outlet water temperature of the cooling water after heat transfer through the inner cylinder wall may be obtained by formula (13).

the second heat transfer amount between the cooling water and the outer cylinder wall can be obtained according to the first outlet water temperature of the cooling water after heat transfer through the inner cylinder wall, in formula (14):

$$Q = α * A * ( {T}_{WB} - {T}_{w} ) \qquad ( 14 )$$

In formula (14), α is a eat transfer coefficient between the cooling water an the outer cylinder wall (i.e., α2 in formula (4)); A is a heat conduction area of the outer cylinder wall; T_{WB} is a first temperature of the outer cylinder wall at the first moment; and T_{w} is the first outlet water temperature of the cooling water after heat transfer through the inner cylinder wall.

The second heat transfer amount between the cooling water and the outer cylinder wall can be calculated by the above formula (14).

Then, through the energy conservation formula for steady-state heat transfer of cooling water in formula (7), a heat transfer amount per unit volume between cooling water and the outer cylinder wall may be obtained, as shown in formula (15):

$${T}_{W , x} = {T}_{B} - {e}^{- \frac{α * {L}_{c} * x}{m * {C}_{p}}} * ( {T}_{B} - {T}_{w , i n} ) \qquad ( 15 )$$

In formula (15), T_{W,x} is a temperature within each length between the cooling water and the outer cylinder wall, T_{B} is a temperature of the inner cylinder wall at the second moment; α is a heat transfer coefficient between the cooling water and the outer cylinder wall (i.e., α2 in formula (4)); A is a heat conduction area of the outer cylinder wall; L_{c} is a characteristic length of the outer cylinder wall, indicating the corresponding heat transfer area per unit length; x is a length of the inner cylinder wall; Cₚ is a constant-pressure specific heat capacity of the cooling water and T_{w,in} is a first outlet water temperature of the cooling water after heat transfer through the inner cylinder wall.

Then, the above formula (15) is integrated with respect to the length from the inlet to the outlet of the outer cylinder wall to obtain the second relationship between the first outlet water temperature, the second outlet water temperature of the cooling water after heat transfer through the outer cylinder wall, and the first temperature of the outer cylinder wall at the first moment as shown in formula (16):

$$Q = {\int }_{0}^{L} α * {L}_{c} * dx * ( {T}_{W , x} - {T}_{WB} ) {d}_{x} = α * A * ( {T}_{B} - {T}_{WB} ) - \dot{m} {C}_{p} ( {T}_{B} - {T}_{w , i n} ) ( 1 - {e}^{- \frac{α * A}{m * {C}_{p}}} ) \qquad ( 16 )$$

In formula (16), α is a heat transfer coefficient between the cooling water and the outer cylinder wall (i.e., α2 in formula (4)); A is a heat conduction area of the outer cylinder wall; T_{B} is a temperature of the inner cylinder wall at the second moment; T_{WB} is a first temperature of the outer cylinder wall at the first moment; n is a mass flow rate of the cooling water; Cₚ is a constant-pressure specific heat capacity of the cooling water; T_{w,in} is a first outlet water temperature of the cooling water after heat transfer through the inner cylinder wall; and m is the mass of the outer cylinder wall.

According to the above formula (16) and formula (15), the second outlet water temperature after heat transfer between the cooling water and the outer cylinder wall can be obtained, that is, the cooling water temperature at the second moment.

In the embodiment of the present disclosure, by calculating the temperature at which the inner cylinder wall transfers heat to the cooling water, and the temperature at which the cooling water transfers heat to the outer cylinder wall, the final cooling water temperature can be obtained accurately.

At step 240, an outer cylinder wall temperature at the second moment is calculated according to a first temperature of the outer cylinder wall at the first moment, a heat transfer principle relationship between the outer cylinder wall and cooling water, and a heat transfer principle relationship between the outer cylinder wall and the external environment.

In order to accurately calculate the outer cylinder wall temperature at the second moment, the above step 240 may specifically include:
calculating a second temperature of the outer cylinder wall after the cooling water transfers heat to the outer cylinder wall according to the first temperature of the outer cylinder wall at the first moment, the cooling water temperature at the second moment, and the heat transfer principle relationship between the outer cylinder wall and the cooling water; and
calculating an outer cylinder wall temperature after the outer cylinder wall transfers heat with the external environment according to the second temperature and the heat transfer principle relationship between the outer cylinder wall and the external environment.

The second temperature may be a temperature of the outer cylinder wall after the cooling water transfers heat to the outer cylinder wall.

In some embodiments of the present disclosure, according to the first temperature of the outer cylinder wall at the first moment and the cooling water temperature at the second moment, the heat transfer amount transferred from the cooling water to the outer cylinder wall can be calculated through the heat transfer principle relationship between the outer cylinder wall and the cooling water in formula (14).

Then, the heat transfer amount transferred from the cooling water to the outer cylinder wall and the following formula (17) can be used to calculate the second temperature of the outer cylinder wall after the cooling water transfers heat to the outer cylinder wall.

$$Q = m * {C}_{p} * {dT}_{WB} \qquad ( 17 )$$

In formula (17), Q is a heat transfer amount transferred from the cooling water to the outer cylinder wall; m is the mass of the outer cylinder wall; Cₚ is a specific heat capacity of the outer cylinder wall; dT_{WB} is a difference between the first temperature of the outer cylinder wall at the first moment and the second temperature of the outer cylinder wall after the cooling water transfers heat to the outer cylinder wall.

In this way, the second temperature of the outer cylinder wall after the cooling water transfers heat to the outer cylinder wall can be calculated by the above formula (17).

Then, the heat transfer amount between the outer cylinder wall and the external environment is calculated according to the second temperature and the heat transfer principle relationship between the outer cylinder wall and the external environment shown in formula (18).

$$Q = α * A * ( {T}_{WB} - {T}_{amb} ) \qquad ( 18 )$$

In formula (18), Q is a heat transfer between the outer cylinder wall and the external environment; α is a heat transfer coefficient between the outer cylinder wall and the external environment; A is a heat conduction area of the outer cylinder wall; T_{WB} is a second temperature of the outer cylinder wall after the cooling water transfers heat to the outer cylinder wall; T_{amb} is a first temperature of the external environment at the first moment.

Then, the outer cylinder wall temperature after the outer cylinder wall transfers heat with the external environment can be calculated according to the heat transfer amount between the outer cylinder wall and the external environment and formula (19).

$$Q = m * {C}_{p} * {dT}_{WB} \qquad ( 19 )$$

In formula (17), Q is a heat transfer transferred between the outer cylinder wall and the external environment; m is the mass of the outer cylinder wall; Cₚ is a specific heat capacity of the cooling water; dT_{WB} is a difference between the second temperature of the outer cylinder wall after the cooling water transfers heat to the outer cylinder wall, and the temperature of the outer cylinder wall after the outer cylinder wall transfers heat to the external environment.

In this way, the temperature of the outer cylinder wall after heat transfer transferred between the outer cylinder wall and the external environment can be calculated by the above formula (19).

In an embodiment of the present disclosure, the second temperature of the outer cylinder wall after the cooling water transfers heat to the outer cylinder wall is calculated according to the first temperature of the outer cylinder wall at the first moment, the cooling water temperature at the second moment, and the heat transfer principle relationship between the outer cylinder wall and the cooling water; then the outer cylinder wall temperature after the outer cylinder wall transfers heat with the external environment can be accurately calculated according to the second temperature, and the heat transfer principle relationship between the outer cylinder wall and the external environment.

The cooling system temperature at the second moment can be calculated according to the first temperature of the cooling system at the first moment, then the cooling system temperature at the second moment is used as the first temperature of the cooling system at the first moment, and a cooling system temperature at a next moment spacing a unit time step from the second moment is calculated. As such, this process is iterated continuously until the cooling system temperature (i.e., the target temperature) at the target moment is calculated.

It should be noted that the method for predicting a temperature of an engine cooling system according to the embodiment of the present disclosure may be executed by an apparatus for predicting the temperature of the engine cooling system, or a control module in the apparatus for executing the method for predicting the temperature of the engine cooling system.

According to the same inventive concept as the above-mentioned method for predicting a temperature of an engine cooling system, the present disclosure also provides an apparatus for predicting a temperature of an engine cooling system. The apparatus for predicting the temperature of the engine cooling system according to the embodiment of the present disclosure is described in detail below in conjunction with FIG. 4.

FIG. 4 is a structural diagram of an apparatus for predicting temperature of an engine cooling system according to an exemplary embodiment.

As shown in FIG. 4, the apparatus 400 for predicting temperature of an engine cooling system may include:
an obtaining module 410, configured to obtain a first temperature of the engine cooling system at an initial moment, operating parameters of an engine and a target moment, in which the engine cooling system comprises at least cooling water, an inner cylinder wall and an outer cylinder wall;
a first determining module 420, configured to determine a number of unit time steps required from the initial moment to the target moment according to a preset unit time step; and
a second determining module 430, configured to obtain a target temperature of the engine cooling system at the target moment by performing a set number of iterative calculations according to the first temperature and the operating parameters of the engine, in which the set number is equal to the number of unit time steps.

In an embodiment of the present disclosure, the obtaining module is configured to obtain the first temperature of the engine cooling system at the initial moment, the operating parameters of the engine, and the target moment, then the first determining module is configured to determine the number of unit time steps required from the initial moment to the target moment, then the second determining module is configured to obtain the target temperature of the engine cooling system at the target moment by performing the set number of iterative calculations according to the first temperature and the operating parameters of the engine. In this way, when calculating the target temperature of the engine cooling system at the target moment, there is no need to refer to immeasurable parameters caused during the use of the engine, such as a cylinder wall roughness of the engine. The target temperature of the engine cooling system at the target moment calculated in this method is more accurate. When calculating the target temperature of the engine cooling system at the target moment, the calculation only needs to rely on the first temperature of the engine cooling system at the initial moment and the operating parameters of the engine, without relying on too many other parameters, thereby saving a calculation time and improving a calculation efficiency of the target temperature of the engine cooling system at the target moment.

In some embodiments of the present disclosure, the second determining module 430 implements each of the iterative calculations including:
calculating a combustion gas temperature of the engine at a second moment according to the operating parameters of the engine at the first moment and a first functional relationship, in which the first functional relationship is obtained by fitting from a double-layer plate model corresponding to the engine; an initial value of the first moment is the initial moment, and the first moment and the second moment are separated by a unit time step; the first functional relationship is a functional relationship between a combustion gas temperature and the operating parameters of the engine;
calculating an inner cylinder wall temperature at the second moment according to a first temperature of the inner cylinder wall at the first moment, a combustion gas temperature at the second moment, and a heat transfer principle relationship between the inner cylinder wall and a combustion gas;
calculating a cooling water temperature at the second moment according to a first temperature of the cooling water at the first moment and a heat transfer principle relationship between the inner cylinder wall and the cooling water; and
calculating an outer cylinder wall temperature at the second moment according to a first temperature of the outer cylinder wall at the first moment, a heat transfer principle relationship between the outer cylinder wall and the cooling water, and a heat transfer principle relationship between the outer cylinder wall and an external environment.

In some embodiments of the present disclosure, in order to accurately calculate the cooling water temperature at the second moment, the second determining module may be specifically configured to:
calculate, based on a steady-state heat transfer formula, a first heat transfer amount between the cooling water and the inner cylinder wall according to the first temperature of the cooling water at the first moment and the inner cylinder wall temperature at the second moment;
obtain a first relationship by performing integration on a length from an inlet to an outlet of the inner cylinder wall according to the first heat transfer amount, in which the first relationship is a relationship between the first temperature of the cooling water, a first outlet water temperature of the cooling water after heat transfer through the inner cylinder wall and the inner cylinder wall temperature;
calculate a first outlet water temperature of the cooling water after heat transfer through the inner cylinder wall according to the first relationship, the first temperature of the cooling water at the first moment and the inner cylinder wall temperature at the second moment;
calculate a second heat transfer amount between the cooling water and the outer cylinder wall according to the first outlet water temperature and the first temperature of the outer cylinder wall at the first moment;
obtain a second relationship by performing integration on the length from the inlet to the outlet of the outer cylinder wall according to the second heat transfer amount, in which the second relationship is a relationship between the first outlet water temperature and a second outlet water temperature of the cooling water after heat transfer through the outer cylinder wall, and the first temperature of the outer cylinder wall at the first moment; and
calculate the second outlet water temperature of the cooling water after heat transfer through the outer cylinder wall according to the second relationship, the first outlet water temperature and the first temperature of the outer cylinder wall at the first moment, in which the cooling water temperature at the second moment is the second outlet water temperature.

In some embodiments of the present disclosure, in order to accurately calculate the outer cylinder wall temperature at the second moment, the second determining module may be specifically configured to:
calculate a second temperature of the outer cylinder wall after the cooling water transfers heat to the outer cylinder wall according to the first temperature of the outer cylinder wall at the first moment, the cooling water temperature at the second moment, and the heat transfer principle relationship between the outer cylinder wall and the cooling water; and
calculate an outer cylinder wall temperature after the outer cylinder wall transfers heat with the external environment according to the second temperature and the heat transfer principle relationship between the outer cylinder wall and the external environment.

In some embodiments of the present disclosure, in order to further improve the accuracy and efficiency of predicting the temperature of the engine cooling system, the above mentioned apparatus for predicting the temperature of the engine cooling system may also include:
a third determining module, configured to obtain a first corresponding relationship for a heat transfer coefficient between the operating parameters of the engine and the combustion gas, by fitting historical operating parameters of the engine, the heat transfer coefficient between the historical operating parameters and the combustion gas;
a fourth determining module, configured to obtain a second corresponding relationship for a heat transfer coefficient between a mass flow rate of cooling water and the cylinder wall of the engine, by fitting the mass flow rate of cooling water, the heat transfer coefficient between the mass flow rate of cooling water and the cylinder wall of the engine;
a fifth determining module, configured to obtain the functional relationship between the combustion gas temperature and the operating parameters of the engine, by fitting the first corresponding relationship and the second corresponding relationship according to a double-layer flat plate model corresponding to the engine and an energy conservation formula for steady-state heat transfer between the cooling water and the combustion gas within the engine.

In some embodiments of the present disclosure, in order to further improve the accuracy and efficiency of predicting the temperature of the engine cooling system, the fifth determining module may be specifically configured to:
obtain a heat conduction thermal resistance relationship within the engine, by fitting the first corresponding relationship and the second corresponding relationship according to a first heat transfer area between the inner cylinder wall and the combustion gas, a second heat transfer area between the inner cylinder wall and the cooling water, and a heat conduction area of the inner cylinder wall;
obtain a third relationship by performing integration on a length from an inlet to an outlet of the inner cylinder wall within the engine according to the heat conduction thermal resistance relationship and the double-layer plate model corresponding to the engine, as well as an energy conservation formula for steady-state heat transfer between the cooling water and the combustion gas within the engine, in which the third relationship is a relationship between the combustion gas, an inlet temperature of the cooling water and an outlet temperature of the cooling water; and
obtaining a functional relationship between the combustion gas temperature and the operating parameters of the engine by performing a quadratic function fitting for the third relationship and the operating parameters of the engine.

In some embodiments of the present disclosure, the functional relationship between the combustion gas temperature and the operating parameters of the engine is:

$${T}_{gas} = a * {n}^{2} - b * {T}^{2} - c * n * T + d * n + e * T * f$$

where T_{gas} is a virtual combustion temperature; n is an engine speed, T is an engine torque; a, b, c, d, e and f are all constants determined according to a model of the engine.

The apparatus for predicting a temperature of an engine cooling system according to the embodiment of the present disclosure can be used to execute the method for predicting a temperature of an engine cooling system according to the above-mentioned method embodiments. The implementation principle and technical effect in the apparatus embodiments are similar with those in the method embodiments, which will not be repeated here for the sake of brief introduction.

According to the same inventive concept, an embodiment of the present disclosure also provides an electronic device.

FIG. 5 is a structure diagram of an electronic device according to an embodiment of the present disclosure. As shown in FIG. 5, the electronic device may include a processor 501 and a memory 502 storing computer programs or instructions.

Specifically, the processor 501 may include a central processing unit (CPU), or an application specific integrated circuit (ASIC), or may be configured to implement one or more integrated circuits of the embodiments of the present invention.

The memory 502 may include a memory with high capacity for data or instructions. By way of example and not limitation, the memory 502 may include a hard disk drive (HDD), a floppy disk drive, flash memory, an optical disk, a magneto-optical disk, a magnetic tape, or a universal serial bus (USB) drive, or a combination of two or more of the above. The memory 502 may include removable or non-removable (or fixed) media, where appropriate. If appropriate, the memory 502 may be located inside or outside the integrated gateway redundancy device. In a particular embodiment, the memory 502 is non-volatile solid-state memory. The memory may include a read-only memory (ROM), a random-access memory (RAM), a magnetic disk storage medium device, an optical storage medium device, a flash memory device, an electrical, optical or other physical/tangible memory storage device. Therefore, the memory typically includes one or more tangible (non-transitory) computer-readable storage media (e.g., memory devices) encoded with software including computer-executable instructions, and when the software is executed (e.g., by one or more processors), it is operable to perform the operations described in the method for predicting a temperature of an engine cooling system according to the above-mentioned embodiments.

The processor 501 reads and executes the computer program instructions stored in the memory 502, to implement any one of the method for predicting a temperature of an engine cooling systems in the above embodiments.

In an example, the electronic device may further include a communication interface 503 and a bus 510. As shown in FIG. 5, the processor 501, the memory 502, and the communication interface 503 are connected via the bus 510 and communicate with each other.

The communication interface 503 is mainly used to implement the communication between the modules, devices, units and/or devices in the embodiment of the present invention.

The bus 510 includes hardware, software, or both, and couples components of the electronic device to each other. By way of example, and not limitation, the bus may include an accelerated graphics port (AGP) or other graphics bus, an enhanced industry standard architecture (EISA) bus, a front side bus (FSB), a hypertransport (HT) interconnect, an industry standard architecture (ISA) bus, an infiniband interconnect, a low pin count (LPC) bus, a memory bus, a micro channel architecture (MCA) bus, a peripheral component interconnect (PCI) bus, a PCI-express (PCI-X) bus, a serial advanced technology attachment (SATA) bus, a video electronics standards association local (VLB) bus, or other suitable busses, or a combination of two or more of the above. The bus 510 may include one or more buses, where appropriate. Although embodiments of the present invention describe and illustrate a particular bus, the present invention contemplates any suitable bus or interconnect.

The electronic device may execute the method for predicting a temperature of an engine cooling system in the embodiment of the present invention, thereby realizing the method for predicting a temperature of an engine cooling system described in FIG. 1.

In addition, in combination with the method for predicting a temperature of an engine cooling system in the above embodiment, the embodiment of the present invention may provide a readable storage medium to implement it. The readable storage medium stores program instructions. When the program instructions are executed by the processor, any one of the method for predicting a temperature of an engine cooling systems in the above embodiments is implemented.

In addition, in combination with the method for predicting a temperature of an engine cooling system in the above embodiment, the embodiment of the present invention may provide a vehicle for implementation. The vehicle includes the apparatus for predicting a temperature of an engine cooling system, the device for predicting a temperature of an engine cooling system and a computer-readable storage medium in the above-mentioned embodiments.

It should be understood that the present invention is not limited to the specific configurations and processes described above and shown in the drawings. For the sake of brevity, a detailed description of the known methods is omitted here. In the above embodiments, several specific steps are described and illustrated as examples. However, the method process of the present invention is not limited to the specific steps described and shown. Those skilled in the art may make various changes, modifications and additions, or change the order of the steps after understanding the scope of the present invention.

The functional blocks shown in the above structural diagram may be implemented in hardware, software, firmware or a combination thereof. When implemented in hardware, it may be, for example, an electronic circuit, an application specific integrated circuit (ASIC), an appropriate firmware, a plug-in, a function card, and the like. When implemented in software, elements of the present invention are programs or code segments used to perform the required tasks. The program or code segments may be stored in a machine-readable medium or transmitted over a transmission medium or a communication link via a data signal carried in a carrier wave. “Machine-readable media” may include any media that may store or transmit information. Examples of machine-readable media include electronic circuits, semiconductor memory devices, an ROM, a flash memory, an erasable ROM (EROM), floppy disks, CD-ROMs, optical disks, hard disks, fiber optic media, radio frequency (RF) links, and the like. The code segments may be downloaded via a computer network such as the Internet, an intranet, or the like.

It should also be noted that the exemplary embodiments mentioned in the present invention describe some methods or systems based on a series of steps or devices. However, the present invention is not limited to the sequence of the above steps, that is, the steps may be executed in the sequence mentioned in the embodiments, or may be different from the sequence in the embodiments, or several steps may be executed simultaneously.

Aspects of the present disclosure are described above with reference to flowcharts and/or block diagrams of methods, apparatus (systems) and computer program products according to embodiments of the present disclosure. It will be understood that each block of the flowchart and/or block diagrams, and a combination of blocks in the flowchart and/or block diagrams, may be implemented by computer program instructions. These computer program instructions may be provided to a processor of a general-purpose computer, a special-purpose computer, or other programmable data processing device to produce a machine, so that these instructions executed by the processor of the computer or other programmable data processing device enable the functions/actions specified in one or more blocks of the flowchart and/or block diagram to be implemented. Such a processor may be, but is not limited to, a general-purpose processor, a dedicated processor, a special application processor, or a field programmable logic circuit. It may also be understood that each box in the block diagram and/or flowchart, and a combination of boxes in the block diagram and/or flowchart, may also be implemented by dedicated hardware that performs the specified function or action, or may be implemented by a combination of dedicated hardware and computer instructions.

An embodiment of the present disclosure provides a computer program product, including a computer program, which when executed by a processor, implements the method for predicting a temperature of an engine cooling system as described above.

It should be noted that, relational terms in this disclosure such as “first” and “second” are merely used to distinguish one entity or operation from another entity or operation, and do not necessarily require or imply any actual relationship or order between these entities or operations. Moreover, the term “include” or any other variation thereof is intended to cover a non-exclusive inclusion, such that a process, method, article, or apparatus that includes a list of elements includes not only those elements but also other elements not expressly listed, or also includes elements inherent to such process, method, article, or apparatus. Without more constraints, an element defined by the phrase “including a . . . ” does not exclude an existence of other identical elements in the process, method, article or apparatus including the element.

The above description is only a specific implementation of the present invention. Those skilled in the art may clearly understand that for the convenience and conciseness of description, the specific working processes of the systems, modules and units described above may refer to the corresponding processes in the aforementioned method embodiments and will not be repeated here. It should be understood that the protection scope of the present invention is not limited thereto, and any skilled person familiar with the technical field can easily think of various equivalent modifications or substitutions within the technical scope disclosed by the present invention, and these modifications or substitutions should be included in the protection scope of the present invention.

1. A computer-implemented method for predicting a temperature of an engine cooling system, comprising:
obtaining a first temperature of the engine cooling system at an initial moment, operating parameters of an engine and a target moment, wherein the engine cooling system comprises at least a cooling water, an inner cylinder wall and an outer cylinder wall;
determining a number of unit time steps required from the initial moment to the target moment according to a preset unit time step; and
obtaining a target temperature of the engine cooling system at the target moment by performing a set number of iterative calculations according to the first temperature of the engine cooling system and the operating parameters of the engine, wherein the set number is equal to the number of unit time steps,
wherein each iterative calculation comprises:
calculating a combustion gas temperature of the engine at a second moment according to the operating parameters of the engine at a first moment and a first functional relationship, wherein the first functional relationship is obtained by fitting from a double-layer plate model corresponding to the engine; an initial value of the first moment is the initial moment, and the first moment and the second moment are separated by the preset unit time step; the first functional relationship is a functional relationship between the combustion gas temperature and the operating parameters of the engine;
calculating an inner cylinder wall temperature at the second moment according to a first temperature of the inner cylinder wall at the first moment, the combustion gas temperature of the engine at the second moment, and a heat transfer principle relationship between the inner cylinder wall and a combustion gas;
calculating a cooling water temperature at the second moment according to a first temperature of the cooling water at the first moment and a heat transfer principle relationship between the inner cylinder wall and the cooling water; and
calculating an outer cylinder wall temperature at the second moment according to a first temperature of the outer cylinder wall at the first moment, a heat transfer principle relationship between the outer cylinder wall and the cooling water, and a heat transfer principle relationship between the outer cylinder wall and an external environment.

2. (canceled)

3. The method according to claim 1, wherein calculating the cooling water temperature at the second moment according to the first temperature of the cooling water at the first moment and the heat transfer principle relationship between the inner cylinder wall and the cooling water comprises:
calculating, based on a steady-state heat transfer formula, a first heat transfer amount between the cooling water and the inner cylinder wall according to the first temperature of the cooling water at the first moment and the inner cylinder wall temperature at the second moment;
obtaining a first relationship by performing integration on a length from an inlet to an outlet of the inner cylinder wall according to the first heat transfer amount, wherein the first relationship is a relationship between the first temperature of the cooling water, a first outlet water temperature of the cooling water after heat transfer through the inner cylinder wall and the inner cylinder wall temperature;
calculating a first outlet water temperature of the cooling water after heat transfer through the inner cylinder wall according to the first relationship, the first temperature of the cooling water at the first moment and the inner cylinder wall temperature at the second moment;
calculating a second heat transfer amount between the cooling water and the outer cylinder wall according to the first outlet water temperature and the first temperature of the outer cylinder wall at the first moment;
obtaining a second relationship by performing integration on the length from the inlet to the outlet of the outer cylinder wall according to the second heat transfer amount, wherein the second relationship is a relationship between the first outlet water temperature and a second outlet water temperature of the cooling water after heat transfer through the outer cylinder wall, and the first temperature of the outer cylinder wall at the first moment; and
calculating the second outlet water temperature of the cooling water after heat transfer through the outer cylinder wall according to the second relationship, the first outlet water temperature and the first temperature of the outer cylinder wall at the first moment, wherein the cooling water temperature at the second moment is the second outlet water temperature.

4. The method according to claim 1, wherein calculating the outer cylinder wall temperature at the second moment according to the first temperature of the outer cylinder wall at the first moment, the heat transfer principle relationship between the outer cylinder wall and the cooling water, and the heat transfer principle relationship between the outer cylinder wall and the external environment comprises:
calculating a second temperature of the outer cylinder wall after the cooling water transfers heat to the outer cylinder wall according to the first temperature of the outer cylinder wall at the first moment, the cooling water temperature at the second moment, and the heat transfer principle relationship between the outer cylinder wall and the cooling water; and
calculating an outer cylinder wall temperature after the outer cylinder wall transfers heat with the external environment according to the second temperature and the heat transfer principle relationship between the outer cylinder wall and the external environment.

5. The method according to claim 1, wherein before obtaining the first temperature of the engine cooling system at the initial moment, the operating parameters of the engine and the target moment, the method further comprises:
obtaining a first corresponding relationship for a heat transfer coefficient between the operating parameters of the engine and the combustion gas, by fitting historical operating parameters of the engine, the heat transfer coefficient between the historical operating parameters and the combustion gas;
obtaining a second corresponding relationship for a heat transfer coefficient between a mass flow rate of the cooling water and the cylinder wall of the engine, by fitting the mass flow rate of the cooling water, the heat transfer coefficient between the mass flow rate of the cooling water and the cylinder wall of the engine; and
obtaining the functional relationship between the combustion gas temperature and the operating parameters of the engine, by fitting the first corresponding relationship and the second corresponding relationship according to a double-layer flat plate model corresponding to the engine and an energy conservation formula for steady-state heat transfer between the cooling water and the combustion gas within the engine.

6. The method according to claim 5, wherein obtaining the functional relationship between the combustion gas temperature and the operating parameters of the engine, by fitting the first corresponding relationship and the second corresponding relationship according to the double-layer flat plate model corresponding to the engine and the energy conservation formula for steady-state heat transfer between the cooling water and the combustion gas within the engine comprises:
obtaining a heat conduction thermal resistance relationship within the engine, by fitting the first corresponding relationship and the second corresponding relationship according to a first heat transfer area between the inner cylinder wall and the combustion gas, a second heat transfer area between the inner cylinder wall and the cooling water, and a heat conduction area of the inner cylinder wall;
obtaining a third relationship by performing integration on a length from an inlet to an outlet of the inner cylinder wall within the engine according to the heat conduction thermal resistance relationship and the double-layer plate model corresponding to the engine, as well as the energy conservation formula for steady-state heat transfer between the cooling water and the combustion gas within the engine, wherein the third relationship is a relationship between the combustion gas, an inlet temperature of the cooling water and an outlet temperature of the cooling water; and
obtaining a functional relationship between the combustion gas temperature and the operating parameters of the engine by performing a quadratic function fitting for the third relationship and the operating parameters of the engine.

7. The method according to claim 1, wherein the functional relationship between the combustion gas temperature and the operating parameters of the engine is:
$${T}_{gas} = a * {n}^{2} - b * {T}^{2} - c * n * T + d * n + e * T * f$$
where T_{gas} is a virtual combustion temperature; n is an engine speed, Tis an engine torque; a, b, c, d, e and f are all constants determined according to a model of the engine.

8. (canceled)

9. A device for predicting a temperature of an engine cooling system, comprising: a processor and a memory storing computer program instructions, which, when executed by the processor, the processor is configured to:
obtain a first temperature of the engine cooling system at an initial moment, operating parameters of an engine and a target moment, wherein the engine cooling system comprises at least a cooling water, an inner cylinder wall and an outer cylinder wall;
determine a number of unit time steps required from the initial moment to the target moment according to a preset unit time step; and
obtain a target temperature of the engine cooling system at the target moment by performing a set number of iterative calculations according to the first temperature and the operating parameters of the engine, wherein the set number is equal to the number of unit time steps;
wherein each iterative calculation comprises:
calculating a combustion gas temperature of the engine at a second moment according to the operating parameters of the engine at a first moment and a first functional relationship, wherein the first functional relationship is obtained by fitting from a double-layer plate model corresponding to the engine; an initial value of the first moment is the initial moment, and the first moment and the second moment are separated by the preset unit time step; the first functional relationship is a functional relationship between the combustion gas temperature and the operating parameters of the engine;
calculating an inner cylinder wall temperature at the second moment according to a first temperature of the inner cylinder wall at the first moment, the combustion gas temperature of the engine at the second moment, and a heat transfer principle relationship between the inner cylinder wall and a combustion gas;
calculating a cooling water temperature at the second moment according to a first temperature of the cooling water at the first moment and a heat transfer principle relationship between the inner cylinder wall and the cooling water; and
calculating an outer cylinder wall temperature at the second moment according to a first temperature of the outer cylinder wall at the first moment, a heat transfer principle relationship between the outer cylinder wall and the cooling water, and a heat transfer principle relationship between the outer cylinder wall and an external environment.

10. A non-transitory computer-readable storage medium storing computer program instructions, which, when executed by a processor, a method for predicting a temperature of an engine cooling system is implemented, wherein the method comprises:
obtaining a first temperature of the engine cooling system at an initial moment, operating parameters of an engine and a target moment, wherein the engine cooling system comprises at least a cooling water, an inner cylinder wall and an outer cylinder wall;
determining a number of unit time steps required from the initial moment to the target moment according to a preset unit time step; and
obtaining a target temperature of the engine cooling system at the target moment by performing a set number of iterative calculations according to the first temperature of the engine cooling system and the operating parameters of the engine, wherein the set number is equal to the number of unit time steps;
wherein each iterative calculation comprises:
calculating a combustion gas temperature of the engine at a second moment according to the operating parameters of the engine at a first moment and a first functional relationship, wherein the first functional relationship is obtained by fitting from a double-layer plate model corresponding to the engine; an initial value of the first moment is the initial moment, and the first moment and the second moment are separated by the preset unit time step; the first functional relationship is a functional relationship between the combustion gas temperature and the operating parameters of the engine;
calculating an inner cylinder wall temperature at the second moment according to a first temperature of the inner cylinder wall at the first moment, the combustion gas temperature of the engine at the second moment, and a heat transfer principle relationship between the inner cylinder wall and a combustion gas;
calculating a cooling water temperature at the second moment according to a first temperature of the cooling water at the first moment and a heat transfer principle relationship between the inner cylinder wall and the cooling water; and
calculating an outer cylinder wall temperature at the second moment according to a first temperature of the outer cylinder wall at the first moment, a heat transfer principle relationship between the outer cylinder wall and the cooling water, and a heat transfer principle relationship between the outer cylinder wall and an external environment.

11.-12. (canceled)

13. The device according to claim 9, wherein the processor is further configured to:
calculate, based on a steady-state heat transfer formula, a first heat transfer amount between the cooling water and the inner cylinder wall according to the first temperature of the cooling water at the first moment and the inner cylinder wall temperature at the second moment;
obtain a first relationship by performing integration on a length from an inlet to an outlet of the inner cylinder wall according to the first heat transfer amount, wherein the first relationship is a relationship between the first temperature of the cooling water, a first outlet water temperature of the cooling water after heat transfer through the inner cylinder wall and the inner cylinder wall temperature;
calculate a first outlet water temperature of the cooling water after heat transfer through the inner cylinder wall according to the first relationship, the first temperature of the cooling water at the first moment and the inner cylinder wall temperature at the second moment;
calculate a second heat transfer amount between the cooling water and the outer cylinder wall according to the first outlet water temperature and the first temperature of the outer cylinder wall at the first moment;
obtain a second relationship by performing integration on the length from the inlet to the outlet of the outer cylinder wall according to the second heat transfer amount, wherein the second relationship is a relationship between the first outlet water temperature and a second outlet water temperature of the cooling water after heat transfer through the outer cylinder wall, and the first temperature of the outer cylinder wall at the first moment; and
calculate the second outlet water temperature of the cooling water after heat transfer through the outer cylinder wall according to the second relationship, the first outlet water temperature and the first temperature of the outer cylinder wall at the first moment, wherein the cooling water temperature at the second moment is the second outlet water temperature.

14. The device according to claim 9, wherein the processor is further configured to:
calculate a second temperature of the outer cylinder wall after the cooling water transfers heat to the outer cylinder wall according to the first temperature of the outer cylinder wall at the first moment, the cooling water temperature at the second moment, and the heat transfer principle relationship between the outer cylinder wall and the cooling water; and
calculate an outer cylinder wall temperature after the outer cylinder wall transfers heat with the external environment according to the second temperature and the heat transfer principle relationship between the outer cylinder wall and the external environment.

15. The device according to claim 9, wherein the processor is further configured to:
obtain a first corresponding relationship for a heat transfer coefficient between the operating parameters of the engine and the combustion gas, by fitting historical operating parameters of the engine, the heat transfer coefficient between the historical operating parameters and the combustion gas;
obtain a second corresponding relationship for a heat transfer coefficient between a mass flow rate of the cooling water and the cylinder wall of the engine, by fitting the mass flow rate of the cooling water, the heat transfer coefficient between the mass flow rate of the cooling water and the cylinder wall of the engine; and
obtain the functional relationship between the combustion gas temperature and the operating parameters of the engine, by fitting the first corresponding relationship and the second corresponding relationship according to a double-layer flat plate model corresponding to the engine and an energy conservation formula for steady-state heat transfer between the cooling water and the combustion gas within the engine.

16. The device according to claim 15, wherein the processor is further configured to:
obtain a heat conduction thermal resistance relationship within the engine, by fitting the first corresponding relationship and the second corresponding relationship according to a first heat transfer area between the inner cylinder wall and the combustion gas, a second heat transfer area between the inner cylinder wall and the cooling water, and a heat conduction area of the inner cylinder wall;
obtain a third relationship by performing integration on a length from an inlet to an outlet of the inner cylinder wall within the engine according to the heat conduction thermal resistance relationship and the double-layer plate model corresponding to the engine, as well as the energy conservation formula for steady-state heat transfer between the cooling water and the combustion gas within the engine, wherein the third relationship is a relationship between the combustion gas, an inlet temperature of the cooling water and an outlet temperature of the cooling water; and
obtain a functional relationship between the combustion gas temperature and the operating parameters of the engine by performing a quadratic function fitting for the third relationship and the operating parameters of the engine.

17. The device according to claim 9, wherein the functional relationship between the combustion gas temperature and the operating parameters of the engine is:
$${T}_{gas} = a * {n}^{2} - b * {T}^{2} - c * n * T + d * n + e * T * f$$
where T_{gas} is a virtual combustion temperature; n is an engine speed, Tis an engine torque; a, b, c, d, e and f are all constants determined according to a model of the engine.

18. The storage medium according to claim 10, wherein calculating the cooling water temperature at the second moment according to the first temperature of the cooling water at the first moment and the heat transfer principle relationship between the inner cylinder wall and the cooling water comprises:
calculating, based on a steady-state heat transfer formula, a first heat transfer amount between the cooling water and the inner cylinder wall according to the first temperature of the cooling water at the first moment and the inner cylinder wall temperature at the second moment;
obtaining a first relationship by performing integration on a length from an inlet to an outlet of the inner cylinder wall according to the first heat transfer amount, wherein the first relationship is a relationship between the first temperature of the cooling water, a first outlet water temperature of the cooling water after heat transfer through the inner cylinder wall and the inner cylinder wall temperature;
calculating a first outlet water temperature of the cooling water after heat transfer through the inner cylinder wall according to the first relationship, the first temperature of the cooling water at the first moment and the inner cylinder wall temperature at the second moment;
calculating a second heat transfer amount between the cooling water and the outer cylinder wall according to the first outlet water temperature and the first temperature of the outer cylinder wall at the first moment;
obtaining a second relationship by performing integration on the length from the inlet to the outlet of the outer cylinder wall according to the second heat transfer amount, wherein the second relationship is a relationship between the first outlet water temperature and a second outlet water temperature of the cooling water after heat transfer through the outer cylinder wall, and the first temperature of the outer cylinder wall at the first moment; and
calculating the second outlet water temperature of the cooling water after heat transfer through the outer cylinder wall according to the second relationship, the first outlet water temperature and the first temperature of the outer cylinder wall at the first moment, wherein the cooling water temperature at the second moment is the second outlet water temperature.

19. The storage medium according to claim 10, wherein calculating the outer cylinder wall temperature at the second moment according to the first temperature of the outer cylinder wall at the first moment, the heat transfer principle relationship between the outer cylinder wall and the cooling water, and the heat transfer principle relationship between the outer cylinder wall and the external environment comprises:
calculating a second temperature of the outer cylinder wall after the cooling water transfers heat to the outer cylinder wall according to the first temperature of the outer cylinder wall at the first moment, the cooling water temperature at the second moment, and the heat transfer principle relationship between the outer cylinder wall and the cooling water; and
calculating an outer cylinder wall temperature after the outer cylinder wall transfers heat with the external environment according to the second temperature and the heat transfer principle relationship between the outer cylinder wall and the external environment.

20. The storage medium according to claim 10, wherein before obtaining the first temperature of the engine cooling system at the initial moment, the operating parameters of the engine and the target moment, the method further comprises:
obtaining a first corresponding relationship for a heat transfer coefficient between the operating parameters of the engine and the combustion gas, by fitting historical operating parameters of the engine, the heat transfer coefficient between the historical operating parameters and the combustion gas;
obtaining a second corresponding relationship for a heat transfer coefficient between a mass flow rate of the cooling water and the cylinder wall of the engine, by fitting the mass flow rate of the cooling water, the heat transfer coefficient between the mass flow rate of the cooling water and the cylinder wall of the engine; and
obtaining the functional relationship between the combustion gas temperature and the operating parameters of the engine, by fitting the first corresponding relationship and the second corresponding relationship according to a double-layer flat plate model corresponding to the engine and an energy conservation formula for steady-state heat transfer between the cooling water and the combustion gas within the engine.

21. The storage medium according to claim 20, wherein obtaining the functional relationship between the combustion gas temperature and the operating parameters of the engine, by fitting the first corresponding relationship and the second corresponding relationship according to the double-layer flat plate model corresponding to the engine and the energy conservation formula for steady-state heat transfer between the cooling water and the combustion gas within the engine comprises:
obtaining a heat conduction thermal resistance relationship within the engine, by fitting the first corresponding relationship and the second corresponding relationship according to a first heat transfer area between the inner cylinder wall and the combustion gas, a second heat transfer area between the inner cylinder wall and the cooling water, and a heat conduction area of the inner cylinder wall;
obtaining a third relationship by performing integration on a length from an inlet to an outlet of the inner cylinder wall within the engine according to the heat conduction thermal resistance relationship and the double-layer plate model corresponding to the engine, as well as the energy conservation formula for steady-state heat transfer between the cooling water and the combustion gas within the engine, wherein the third relationship is a relationship between the combustion gas, an inlet temperature of the cooling water and an outlet temperature of the cooling water; and
obtaining a functional relationship between the combustion gas temperature and the operating parameters of the engine by performing a quadratic function fitting for the third relationship and the operating parameters of the engine.

22. The storage medium according to claim 10, wherein the functional relationship between the combustion gas temperature and the operating parameters of the engine is:
$${T}_{gas} = a * {n}^{2} - b * {T}^{2} - c * n * T + d * n + e * T * f$$
where T_{gas} is a virtual combustion temperature; n is an engine speed, Tis an engine torque; a, b, c, d, e and f are all constants determined according to a model of the engine.
